(19) United States
(12) Patent Application Publication
(10) Pub. No.: US 2003/0131574 A1
(43) Pub. Date: Jul. 17, 2003

(54) Collins hitch

(76) Inventors: George Willard Collins, New Albany, IN (US); Billy Dean Collins, Jamestown, KY (US)

Correspondence Address: Billy Dean Collins, 1764 Coffey School Road, Jamestown, KY, 42629, US

(21) Appl. No.: 10/046,574

(22) Filed: Jan. 16, 2002

(51) Int. Cl. A01D 34/03

(52) U.S. Cl. 56/14.7

(57) ABSTRACT

A front mounted hitching device designed to be attached to a front-end loader and tractor for the purpose of pushing a farm implement and at the same time, towing a farm implement to accomplish a one-step operation such as raking and baling hay.

### CROSS-REFERENCE TO RELATED APPLICATIONS

Not-Applicable

### STATEMENT REGARDING FEDERALLY SPONSORED RESEARCH OR DEVELOPMENT

Not-Applicable

### REFERENCE TO MICROFICHE APPENDIX

Not-Applicable

### BACKGROUND OF THE INVENTION

The Collins Hitch was invented for utilization in the field of agriculture. This present invention relates to tractor-push agriculture equipment. More particularly, this invention relates to an implement that can be utilized by a front-end loader to achieve its' flexibility by the ability to push equipment on all types of terrain.

Therefore a primary objective of the present invention is the ability to push an implement, such as a rake, while towing a baler, to achieve a one-step operation. This application may be applied with different types of implements which necessitates a two-step operation.

### BRIEF SUMMARY OF THE INVENTION

The Collins Hitch is designed to couple farm equipment, such as a wheel rake, to the front-end loader of a farm tractor, thus allowing a one-trip process of raking and baling hay or any other feed which may be utilized in this manner.

### BRIEF DESCRIPTION OF THE SEVERAL VIEWS OF THE DRAWING

FIG. 1 FIG. 1 Front side of the steel plate mounted on front-end loader of tractor (can be adapted to any brand tractor or loader).

FIG. 2 A detailed illustration of the device to be attached to the steel plate as shown in FIG. 1.

FIG. 3 Illustrates in more detail the front of FIG. 1, showing the attachment of the device illustrated in FIG. 2.

### DETAILED DESCRIPTION OF THE INVENTION

In general, this device connects to the front-end loader of any brand tractor and allows the tractor to push any implement, such as a wheel rake. The front-end loader of the tractor allows the operator flexibility in the height needed to achieve proper operation of the device.

In the figures, the steel-plate of this invention is generally designated by the reference numeral 7, and the mounting device is generally designated by the reference numeral 8.

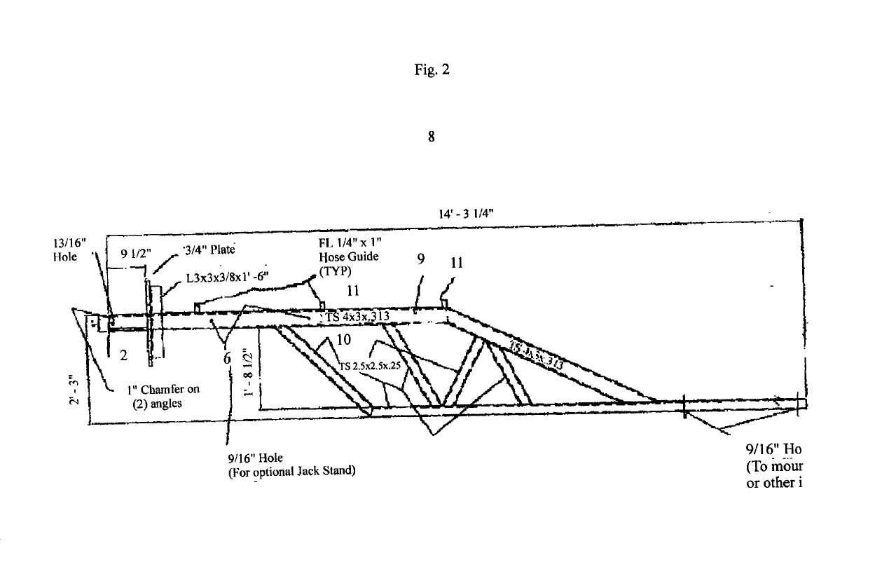

In FIG. 2, 8, the beam 9 is constructed out of material to be a minimum of TS 4×3×0.313, which can vary and be built heavier if the implement being towed requires more strength. The main beam, FIG. 2, 8, is braced 10 by material TS 2.5×2.5×0.25, which also may be up-graded to heavier material if necessary. FIG. 2, 8, the hose-guides 11 are used to secure and hold the hydraulic lines supplied by the implement being pushed.

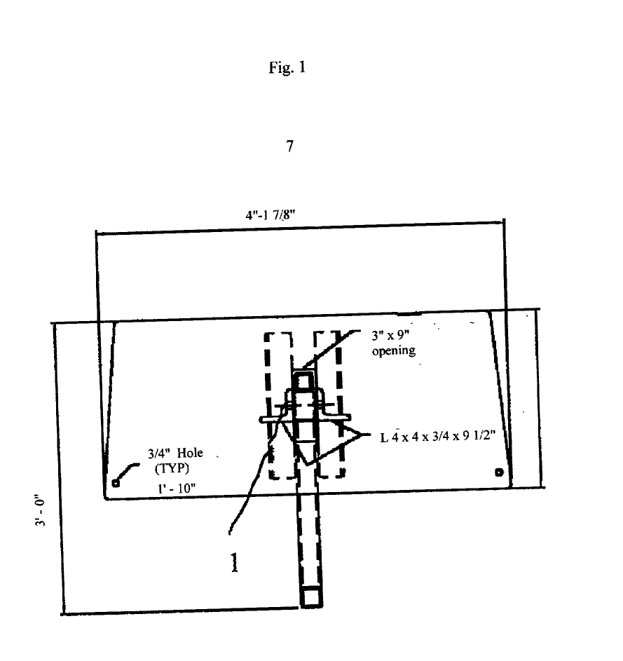

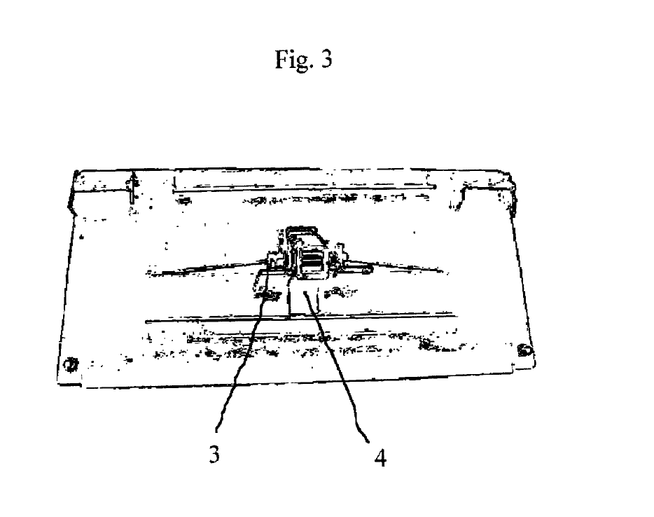

In FIG. 1 of the drawing, the steel-plate 7 attaches directly to an existing front-end loader. Attachment points will vary depending on the model and type of tractor and front-end loader. The portion of the hitch 8 shown in FIG. 2, 2 slides through the opening of the steel-plate shown in FIG. 1, 1 and is attached by a bolt as shown in FIG. 3, 3. The plate (FIG. 1,7) is designed in such a manner to allow the portion of the hitch 8 shown in FIG. 2 to float up and down as depicted in FIG. 3, 4.

FIG. 2, 5 is the portion of the device 8 which inserts (and is secured by a pin) into the implement being pushed. FIG. 2, 6 illustrates a 9/16ths inch hole for optional jack-stand.

1. What I claim as my invention is a front mounted hitching device designed to be coupled to a front-end loader and tractor. This hitching device allows the operator to control and push farm implement equipment such as a rake in the process of rolling hay.
